(19) United States
(12) Patent Application Publication
(10) Pub. No.: US 2014/0179415 A1
(43) Pub. Date: Jun. 26, 2014

(54) COMMUNICATION SYSTEM, METHOD FOR CONTROLLING COMMUNICATION SYSTEM, AND PROGRAM

(71) Applicant: GREE, INC., Tokyo (JP)

(72) Inventor: Shinji MIZUNO, Tokyo (JP)

(73) Assignee: GREE, INC., Tokyo (JP)

(21) Appl. No.: 14/133,031

(22) Filed: Dec. 18, 2013

(30) Foreign Application Priority Data
Dec. 25, 2012 (JP) 2012-281641
Jul. 2, 2013 (JP) 2013-138941

(51) Int. Cl. A63F 13/30

(52) U.S. Cl. CPC A63F 13/12
USPC 463/25

(57) ABSTRACT

A communication system includes communication terminals (2) and a server (1). The server (1) transmits first item data pertaining to a first item to the communication terminals (2) in response to an item acquisition request from any of the communication terminals (2). The server (1) tallies a reception count of the number of times the item acquisition request is received, and when the reception count reaches a predetermined value, transmits second item data pertaining to a second item to the communication terminal (2) that transmitted the item acquisition request for which the reception count reached the predetermined value.

### CROSS-REFERENCE TO RELATED APPLICATION

This application claims priority to and the benefit of Japanese Patent Application No. 2012-281641 filed Dec. 25, 2012, and Japanese Patent Application No. 2013-138941 filed Jul. 2, 2013, the entire contents of which are incorporated herein by reference.

1. Technical Field

The present invention relates to a communication system, a method for controlling a communication system, and a program.

2. Background Art

A competitive game server has been proposed to form a player's deck from game cards or the like stored for each user in the competitive game server and to allow multiple players to compete based on the attack strength and defense strength of the deck (for example, see JP2008220984A (PTL 1)). In such a competitive game server, a user acquires a game card by methods such as purchasing the game card or obtaining the game card by winning a match against a competitor.

### CITATION LIST

### Patent Literature

PTL 1: JP2008220984A

### SUMMARY OF INVENTION

### Technical Problem

In a conventional competitive game server, however, upon a request to purchase an item such as a game card, the item is simply provided in response to the request. The action to purchase an item therefore has no game element and is perceived as monotonous.

The present invention has been conceived in light of the above circumstances and therefore provides a communication system, a method for controlling a communication system, and a program that can increase the variations on methods for acquiring an item in a game and enhance interest in the game.

### Solution to Problem

A communication system according to the present invention includes a plurality of communication terminals and a server. The communication terminals transmit an item acquisition request to the server, and upon receiving the item acquisition request, the server transmits first item data pertaining to a first item to the communication terminals, and when a reception count of a number of times the item acquisition request is received from the communication terminals reaches a predetermined value, transmits second item data pertaining to a second item to a communication terminal, among the communication terminals, that transmitted the item acquisition request for which the reception count reached the predetermined value.

In the communication system according to the present invention, the server may transmit count information pertaining to the reception count to the communication terminals, and the communication terminals may display the reception count based on the count information.

In the communication system according to the present invention, the server may tally a second item transmission count for each user of the communication terminals within a predetermined time period and transmit result information including the second item transmission count to the communication terminals. The communication terminals may display the second item transmission count based on the result information.

In the communication system according to the present invention, the result information may include ranking information pertaining to a ranking of the second item transmission count, and the communication terminals may display the ranking of the user of the communication terminal based on the result information.

In the communication system according to the present invention, the result information may include a user name of each user for which the second item transmission count is at least a predetermined ranking. The communication terminals may display the user name of each user for which the second item transmission count is at least the predetermined ranking.

In the communication system according to the present invention, the server may allocate a user of each communication terminal to a team among a plurality of teams. The reception count may be the number of times the item acquisition request is received for each of the teams. Within a predetermined time period, the server may tally a total second item transmission count team by team for every user belonging to each team and transmits result information including ranking information pertaining to a ranking of the total second item transmission count to the communication terminals. Each communication terminal may display the ranking of the team to which the user of the communication terminal belongs based on the result information.

In the communication system according to the present invention, the communication terminals may transmit a second item acquisition request to the server when the reception count is the predetermined value. The server may tally a second reception count of a number of times the second item acquisition request is received, and when the second reception count reaches a predetermined value, transmit fourth item data pertaining to a fourth item to a communication terminal, among the communication terminals, that transmitted the second item acquisition request for which the second reception count reached the predetermined value.

In the communication system according to the present invention, the server may store related user information pertaining to a related user of a user of each communication terminal. Upon the server transmitting the second item data to the communication terminal, the server may notify the related user that the user has acquired the second item, based on the related user information.

A method according to the present invention for controlling a communication system including a plurality of communication terminals and a server, the server transmitting first item data pertaining to a first item to the communication terminals in response to an item acquisition request from the communication terminals, includes: transmitting, by the communication terminals, the item acquisition request to the server; tallying, by the server, a reception count of a number of times the item acquisition request is received from the communication terminals; determining, by the server, whether the reception count reaches a predetermined value; and transmitting, by the server when the reception count is determined to reach the predetermined value, second item data pertaining to a second item to a communication terminal, among the communication terminals, that transmitted the item acquisition request for which the reception count reached the predetermined value.

The method according to the present invention may further include transmitting, by the server, count information pertaining to the reception count to the communication terminals; and displaying, by the communication terminals, the reception count based on the count information.

The method according to the present invention may further include tallying, by the server, a second item transmission count for each user of the communication terminals within a predetermined time period and transmitting result information including the second item transmission count to the communication terminals; and displaying, by the communication terminals, the second item transmission count based on the result information.

In the method according to the present invention, the result information may include ranking information pertaining to a ranking of the second item transmission count. The communication terminals may display the ranking of the user of each communication terminal based on the result information.

In the method according to the present invention, the result information may include a user name of each user for which the second item transmission count is at least a predetermined ranking, and the communication terminals may display the user name of each user for which the second item transmission count is at least the predetermined ranking.

In the method according to the present invention, the server may allocate a user of each communication terminal to a team among a plurality of teams. The reception count may be the number of times the item acquisition request is received for each of the teams. The method may further include: tallying, by the server, within a predetermined time period, a total second item transmission count team by team for every user belonging to each team and transmitting result information including ranking information pertaining to a ranking of the second item transmission count to the communication terminals; and displaying, by each communication terminal, the ranking of the team to which the user of the communication terminal belongs based on the result information.

The method according to the present invention may further include transmitting, by the communication terminals, a second item acquisition request to the server when the reception count is the predetermined value, and tallying, by the server, a second reception count of a number of times the second item acquisition request is received, and when the second reception count reaches a predetermined value, transmitting fourth item data pertaining to a fourth item to a communication terminal, among the communication terminals, that transmitted the second item acquisition request for which the second reception count reached the predetermined value.

In the method according to the present invention, the server may store related user information pertaining to a related user of a user of each communication terminal. The method may further include: upon the server transmitting the second item data to the communication terminal, notifying, by the server, the related user that the user has acquired the second item, based on the related user information.

A non-transitory computer-readable storage medium stores a program according to the present invention which, when executed by a computer functioning as a communication terminal in a communication system comprising a plurality of communication terminals and a server, the server transmitting first item data pertaining to a first item to the communication terminals in response to an item acquisition request from the communication terminals, causes the computer to perform operations including: receiving second item data pertaining to a second item from the server when a reception count of a number of times the item acquisition request is received by the server reaches a predetermined value.

### Advantageous Effect of Invention

The communication system, method for controlling a communication system, and program according to the present invention increase the variations on methods for acquiring a game card or the like and enhance interest in the game.

### BRIEF DESCRIPTION OF DRAWINGS

The present invention will be further described below with reference to the accompanying drawings, wherein:

FIG. 1 is a block diagram of a communication system according to Embodiment 1;

FIG. 2 is an example of a second item transmission count table;

FIG. 3 is an example of a screen for an item acquisition request;

FIG. 4 is an example of a winning screen and a losing screen;

FIG. 5 is an example of a result information screen according to Embodiment 1;

FIG. 6 is a flowchart illustrating operations of the communication system according to Embodiment 1;

FIG. 7 is a block diagram of a communication system according to Embodiment 2;

FIG. 8 is an example of a team table;

FIG. 9 is an example of a team-by-team count table about transmitting second item;

FIG. 10 is an example of a result information screen according to Embodiment 2;

FIG. 11 is a flowchart illustrating operations of the communication system according to Embodiment 2;

FIG. 12 is a block diagram of a communication system according to Embodiment 3;

FIG. 13 is an example of a fourth item transmission count table;

FIG. 14 is an example of a winning screen in Embodiment 3;

FIG. 15 is an example of a result information screen; and

FIG. 16 is a flowchart illustrating operations of the communication system according to Embodiment 3.

### DESCRIPTION OF EMBODIMENTS

The following describes embodiments of the present invention.

### Embodiment 1

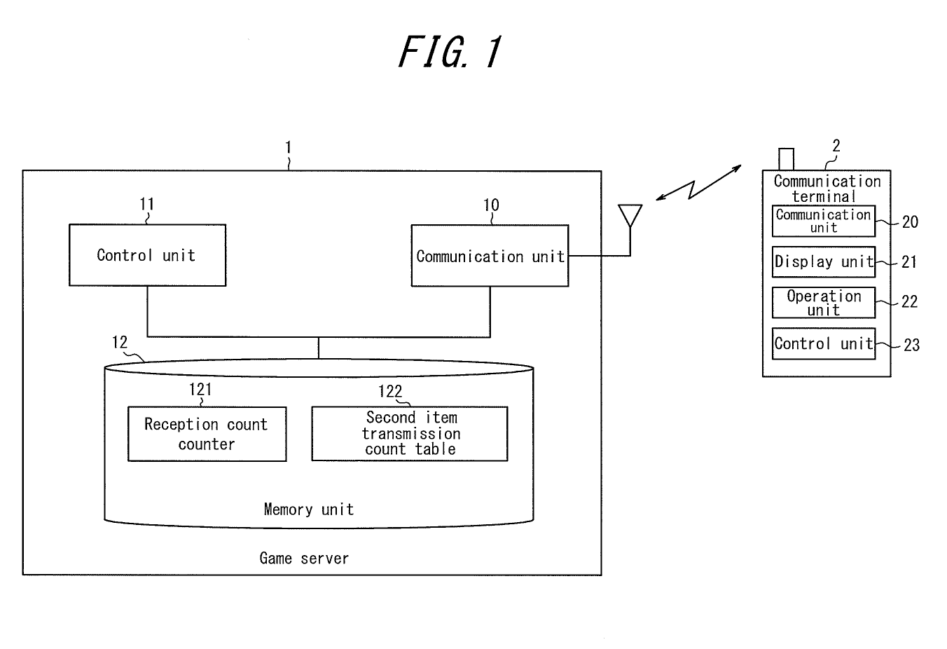

FIG. 1 is a block diagram of a communication system according to Embodiment 1 of the present invention. The communication system according to Embodiment 1 of the present invention includes a server 1 and a communication terminal 2.

The server 1 includes a communication unit 10, a control unit 11, and a memory unit 12.

The communication unit 10 communicates with the communication terminal 2 over either or both of a wireless and wired connection.

The control unit 11 controls the server 1 in a variety of ways. For example, the control unit 11 receives an item acquisition request from the communication terminal 2 via the communication unit 10. In this context, an “item” refers to any of a variety of objects used within a game, such as a game card constituting a user's deck, a character, a weapon, armor, an ornament, a plant, food, and the like. Upon receiving the item acquisition request, the control unit 11 provides a predetermined item (referred to below as a “first item”) to the communication terminal 2. Specifically, the control unit 11 transmits item data pertaining to the first item (referred to below as “first item data”) to the communication terminal 2 via the communication unit 10. The item data is a variety of information, an image, or the like pertaining to an item.

Based on the number of received item acquisition requests (referred to below as a “reception count”), the control unit 11 also provides an additional item (referred to below as a “second item”). Specifically, upon receiving an item acquisition request, the control unit 11 tallies the reception count. Note that in FIG. 1, only one communication terminal 2 is shown, yet when a plurality of communication terminals 2 exist, the reception count is the number of item acquisition requests received from all of the communication terminals 2. When determining that the reception count is a multiple of a predetermined value, the control unit 11 transmits item data pertaining to a second item (referred to below as “second item data”) to the communication terminal 2 in addition to the first item. The predetermined value is, for example 48, in which case the control unit 11 provides the second item to the communication terminal 2 when the reception count is 48 times, 96 times, 144 times, etc. Below, the case of the predetermined value being 48 is described. Furthermore, the reception count being a multiple of the predetermined value is also referred to below as a “win”.

In addition to the second item data, the control unit 11 also transmits winning image data indicating a win to the communication terminal 2 via the communication unit 10. When determining that there is no win, the control unit 11 transmits non-winning image data indicating no win to the communication terminal 2 via the communication unit 10. Furthermore, the control unit 11 transmits information pertaining to the reception count, i.e. the value of a reception count counter. By receiving the winning image data, the non-winning image data, and information on the reception count, the communication terminal 2 can display whether the user has won on a display unit 21.

The control unit 11 also determines whether a predetermined time period has elapsed, and when determining that the predetermined time period has elapsed, transmits result information to the communication terminal 2 via the communication unit 10 after the predetermined time period has elapsed. The result information includes the number of times the second item data has been transmitted (referred to below as a “second item transmission count”). The predetermined time period is, for example, 30 days. Preferably, the result information includes information pertaining to a ranking, among all users of the system, of the second item transmission count for the user of the communication terminal 2. Furthermore, the result information preferably includes a user name for each user having at least a predetermined ranking.

The memory unit 12 stores the items provided to the communication terminal 2, i.e. information pertaining to the first item and the second item. For example, the first item is an item for increasing the rate of progress of an event in the game above the normal level. On the other hand, the second item can be obtained by picking the lock on a treasure chest that appears during the game. The second item is not a particular item, but rather is chosen at random from among a variety of items.

The memory unit 12 also stores a reception count counter 121 for tallying the reception count. Upon receiving an item acquisition request, the control unit 11 increments the reception count counter 121 in the memory unit 12 by one. When the value of the reception count counter 121 reaches the predetermined value, i.e. 48, the control unit 11 resets the reception count counter 121 to zero. In other words, the control unit 11 resets the reception count counter 121 to zero when the reception count is 48 times, 96 times, 144 times, etc. The control unit 11 determines whether the reception count is a multiple of the predetermined value based on whether the value of the reception count counter 121 is 48.

The memory unit 12 also stores a second item transmission count table 122. The second item transmission count table 122 stores the second item transmission count for each user. When determining that the reception count for the item acquisition request from the communication terminal 2 is a multiple of the predetermined value, the control unit 11 increments the second item transmission count for the user of the communication terminal 2 by one. The control unit 11 refers to the second item transmission count table 122 and transmits result information including the second item transmission count to the communication terminal 2 via the communication unit 10.

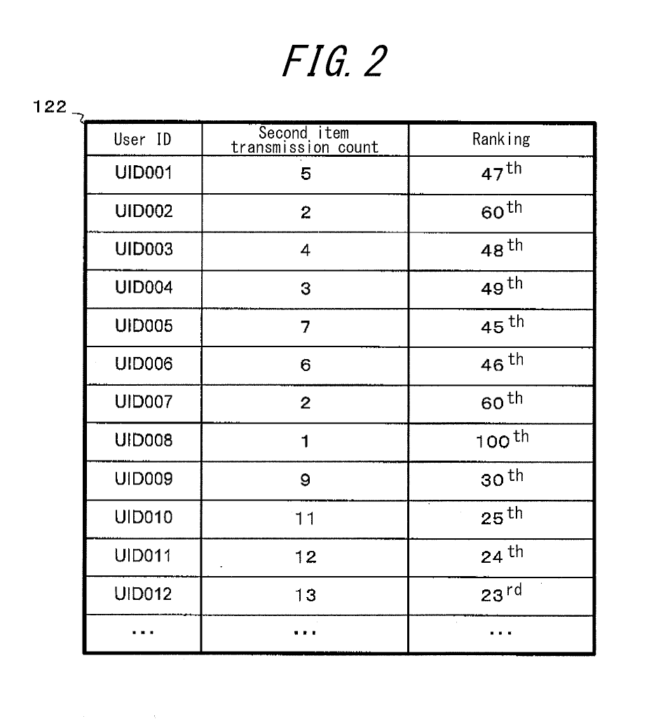

FIG. 2 illustrates an example of the second item transmission count table 122. As illustrated in FIG. 2, the second item transmission count table 122 includes user IDs and second item transmission counts. The user ID is an identifier for uniquely identifying a user of the system. As illustrated in FIG. 2, the second item transmission count table 122 also preferably includes a ranking of the second item transmission count. The ranking is a number indicating the rank when all users are listed in order starting from the largest second item transmission count. For example, the second item transmission count table 122 includes user ID “UID001”, second item transmission count “5”, and ranking “47^{th}”. The user ID may be a user name, a pseudonym, or the like.

The communication terminal 2 includes a communication unit 20, the display unit 21, an operation unit 22, and a control unit 23.

The communication unit 20 communicates with the server 1 over either or both of a wireless and wired connection. Specifically, based on control by the control unit 23, the communication unit 20 transmits an item acquisition request to the server 1. The communication unit 20 also receives an item provided by the server 1 in response to the item acquisition request.

The display unit 21 is configured with a liquid crystal display, an organic EL display, or the like and displays output pertaining to the game provided by the server 1. For example, the display unit 21 displays an item image pertaining to an item provided by the server 1.

The operation unit 22 is configured with buttons, a touchscreen, or the like, and receives an input signal from the user of the game. The operation unit 22 also transmits the input signal received from the user to the control unit 23.

The control unit 23 controls the communication terminal 2 in a variety of ways. For example, based on user operation of the operation unit 22, the control unit 23 transmits an item acquisition request to the server 1 via the communication unit 20.

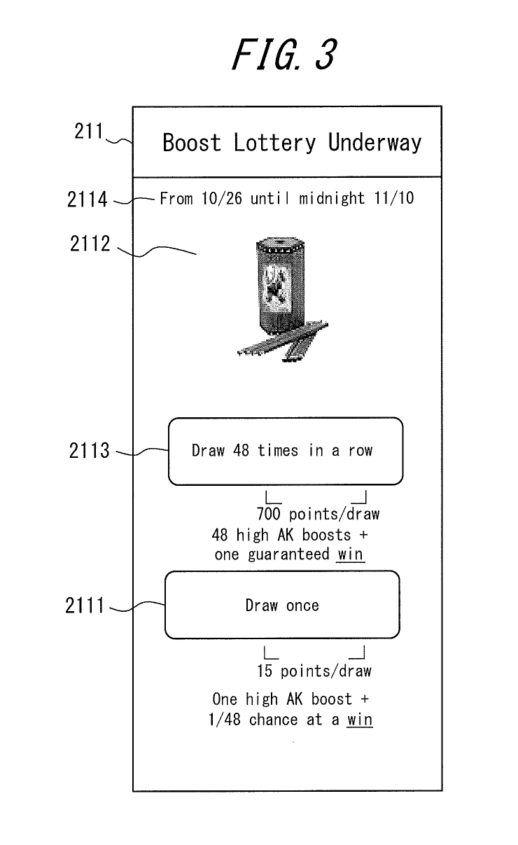

FIG. 3 illustrates an example of an item acquisition request screen 211, displayed on the display unit 21 of the communication terminal 2, for transmitting an item acquisition request. The item acquisition request screen 211 includes an item acquisition request button 2111. The item acquisition request button 2111 is an input interface that accepts input from the user for transmitting an item acquisition request to the server 1. When the operation unit 22 is configured with a touchscreen, the control unit 23 transmits an item acquisition request to the server 1 upon detecting a touch by the user on the item acquisition request button 2111 displayed on the display unit 21.

As illustrated in FIG. 3, a box image 2112 for drawing lots is displayed on the item acquisition request screen 211, and “Boost Lottery Underway” or the like is displayed at the top of the screen. As illustrated in FIG. 3, a request button 2113 for acquiring items continuously is also preferably included. The request button 2113 is an input interface for transmitting an item acquisition request continuously 48 times, which equals the predetermined value. When the communication terminal 2 transmits an item acquisition request to the server 1 with the request button 2113, the user will always obtain the second item. When the control unit 11 of the server 1 receives an item acquisition request from the communication terminal 2 via the request button 2113, the control unit 11 increments the second item transmission count for the user of the communication terminal 2 in the memory unit 12 by one without incrementing the reception count counter 121 in the memory unit 12. Time period information 2114 pertaining to the predetermined time period is also preferably displayed on the item acquisition request screen 211.

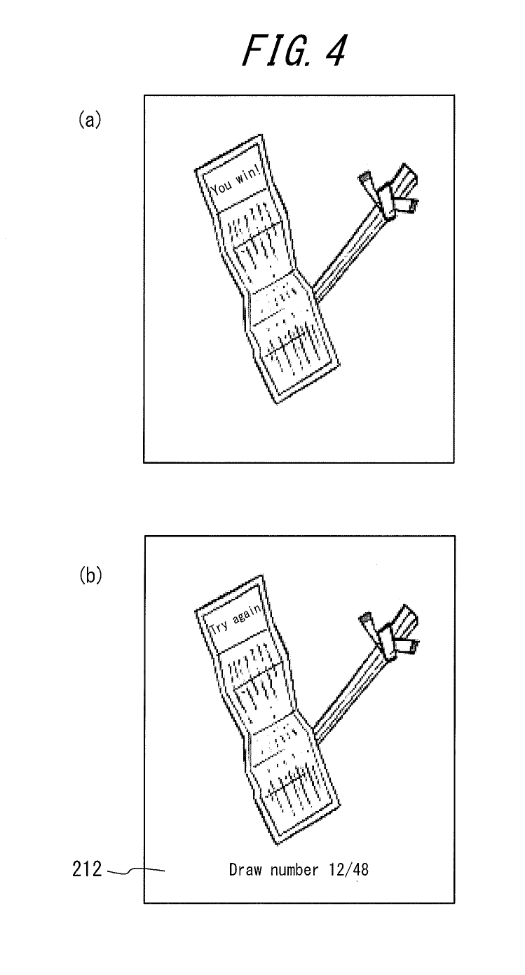

FIG. 4(a) illustrates an example of winning image data displayed on the display unit 21 of the communication terminal 2. The winning image data shows the winning result, for example by displaying a winning fortune that reads “You win!”. This display allows users to tell easily when they have won.

When determining that the reception count for the item acquisition request from the communication terminal 2 is not a multiple of the predetermined value, the control unit 11 transmits non-winning image data (FIG. 4(b)), displaying a non-winning fortune reading “Try again”, to the server 1. The communication terminal 2 then displays the non-winning image data.

When the control unit 11 determines that the reception count for the item acquisition request from the communication terminal 2 is not a multiple of the predetermined value, the server 1 transmits information pertaining to the reception count, i.e. the value of the reception count counter 121, to the communication terminal 2. As illustrated in FIG. 4(b), the display unit 21 of the communication terminal 2 displays a counter value 212 based on the received value of the reception count counter 121. With this display, the reason for not winning can be displayed to the user, thus allowing the user to have a sense of fairness.

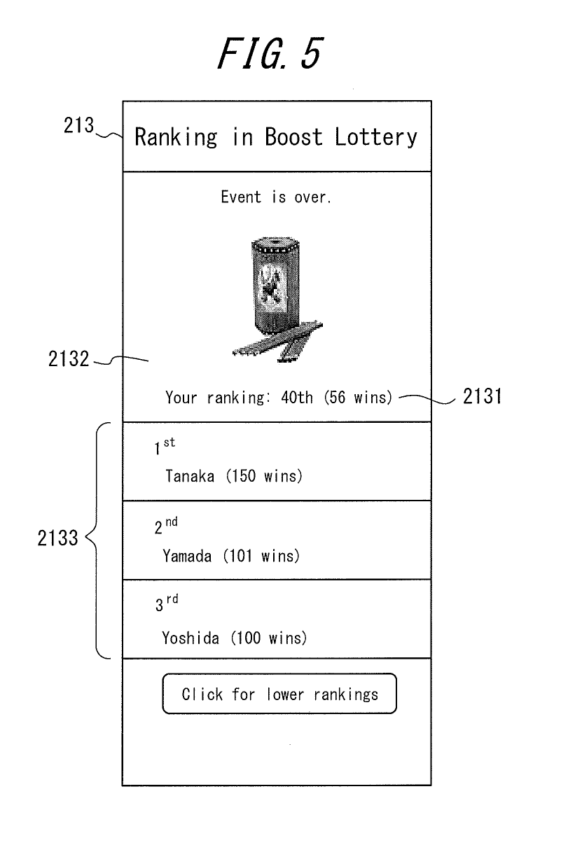

FIG. 5 illustrates an example of a result information screen 213 displayed on the display unit 21 of the communication terminal 2 when the communication terminal 2 receives, from the server 1, result information including the second item transmission count. The result information screen 213 includes count information 2131 about transmitting second item pertaining to the user of the communication terminal 2. As illustrated in FIG. 5, ranking information 2132 for the user is preferably included. As also illustrated in FIG. 5, count information 2133 about transmitting second item with a user name for each user having at least a predetermined ranking, along with the second item transmission count for the user, is more preferably included. FIG. 5 shows an example in which the user name and the second item transmission count are included for the top three users.

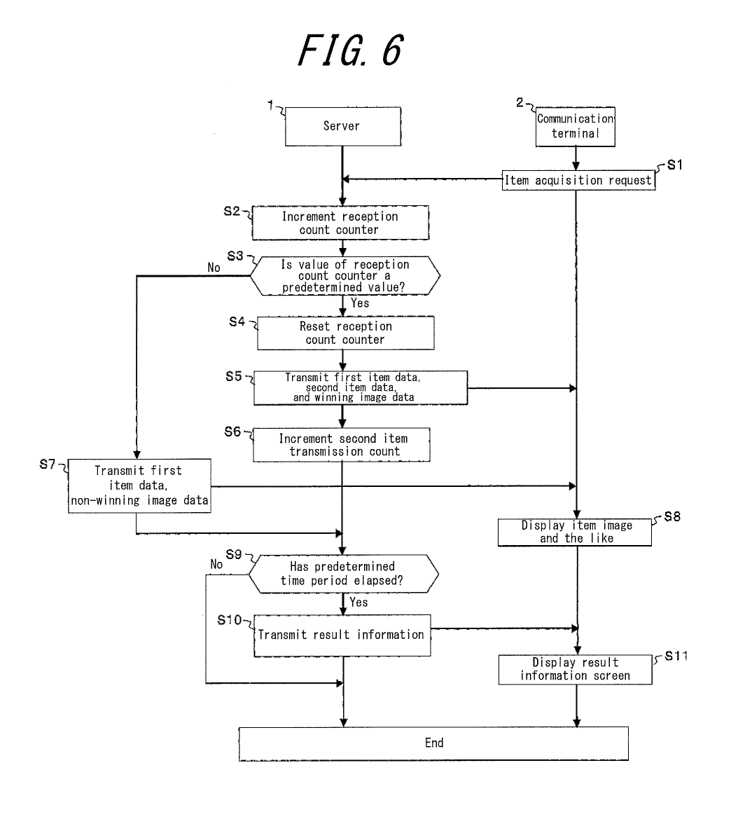

Next, operations of the communication system according to Embodiment 1 are described with reference to the flowchart in FIG. 6.

First, based on user operation of the operation unit 22, the control unit 23 of the communication terminal 2 transmits an item acquisition request to the server 1 via the communication unit 20 (step S1).

Next, upon receiving the item acquisition request, the control unit 11 of the server 1 tallies the reception count (step S2). Specifically, upon receiving the item acquisition request, the control unit 11 increments the reception count counter 121 in the memory unit 12 by one.

The control unit 11 then determines whether the value of the reception count counter 121 is the predetermined value, i.e. 48 (step S3). When the control unit 11 determines that the value of the reception count counter 121 is the predetermined value, processing proceeds to step S4. On the other hand, when the control unit 11 does not determine that the value of the reception count counter 121 is the predetermined value, processing proceeds to step S7.

When determining in step S3 that the value of the reception count counter 121 is the predetermined value, the control unit 11 resets the reception count counter 121 to zero (step S4). The control unit 11 then transmits the first item data, the second item data, and the winning image data to the communication terminal 2 (step S5). Next, the control unit 11 increments the second item transmission count for the user of the communication terminal 2 in the second item transmission count table 122 by one (step S6). Processing then proceeds to step S8. On the other hand, when determining that the value of the reception count counter 121 is not the predetermined value, the control unit 11 transmits the first item data and the non-winning image data to the communication terminal 2 via the communication unit 10 (step S7).

The display unit 21 of the communication terminal 2 then displays an item image pertaining to the received item data and displays either the winning image data or the non-winning image data (step S8).

Next, the control unit 11 of the server 1 determines whether a predetermined time period has elapsed (step S9). When determining that the predetermined time period has elapsed, the control unit 11 transmits result information including the second item transmission count to the communication terminal 2 via the communication unit 10 (step S10). The display unit 21 of the communication terminal 2 then displays the result information screen 213 based on the result information (step S11). Processing then terminates.

Conversely, when the control unit 11 does not determine in step S8 that the predetermined time period has elapsed, processing skips step S9 and terminates.

According to the communication system of Embodiment 1, the control unit 11 of the server 1 thus provides a first item, which is a regular item, as well as an additional item (second item) in accordance with the reception count of the item acquisition request, thereby increasing the variations on methods for acquiring an item.

Note that the control unit 11 of the server 1 may also provide an additional item to the communication terminal 2 of the user at each rank in accordance with the ranking pertaining to the second item transmission count.

When the total of the second item transmission count for all users reaches a predetermined value (such as 4848), the control unit 11 of the server 1 may also provide all users with an additional item.

The reception count counter 121 stored in the memory unit 12 has been described as being reset to zero upon reaching the predetermined value, yet the reception count counter 121 need not be reset to zero. As an alternative configuration, the control unit 11 may determine whether the reception count is a multiple of the predetermined value based on whether the remainder when dividing the value of the reception count counter 121 by the predetermined value is zero. In this case, the control unit 11 transmits the remainder to the communication terminal 2, and the communication terminal 2 displays the counter value 212 in the non-winning image data based on the remainder.

While the predetermined value has been described as being 48, the predetermined value may be less than 48, or may be 49 or greater.

According to the present invention, the reception count being a multiple of a predetermined value also includes the case of when the reception count is only a single multiple of the predetermined value (i.e. 48).

The server 1 may also store information pertaining to any related users that are related to the user of the communication terminal 2. A related user is, for example, a friend of the user in a social networking service. Upon transmitting the second item data to the communication terminal 2, the control unit 11 may, based on the information pertaining to the related user(s), also notify the communication terminal of each related user that the user has acquired the second item. For example, when each item acquisition request requires a predetermined amount of money, the user who acquired the second item data and the related user(s) who received the notification may, at the time of the next item acquisition request, be allowed to make two item acquisition requests for the same amount of money as one.

### Embodiment 2

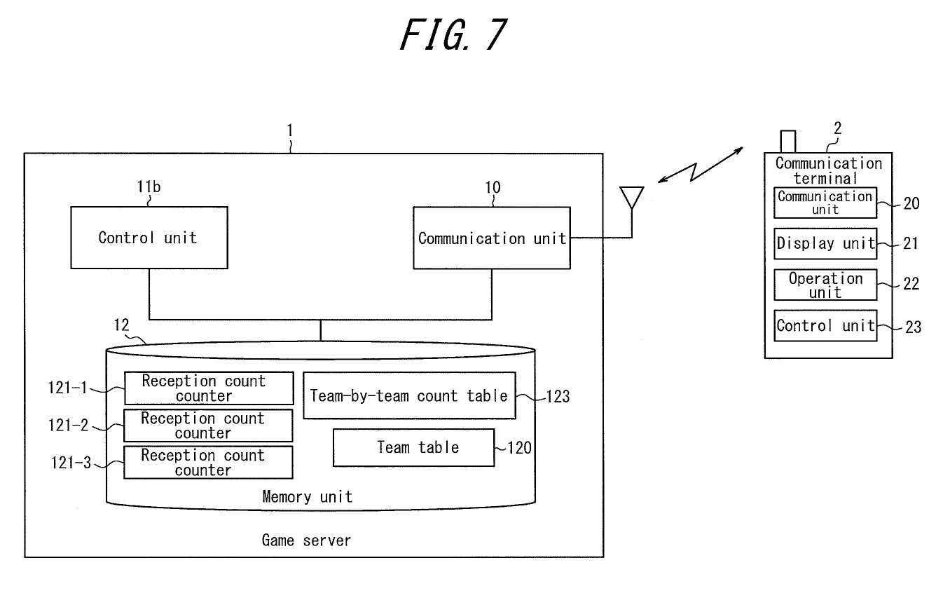

The following describes Embodiment 2 of the present invention. FIG. 7 is a block diagram of a communication system according to Embodiment 2 of the present invention. The same reference signs are provided for the same components as in Embodiment 1, and a description thereof is omitted. The communication system according to Embodiment 2 differs from Embodiment 1 with regard to control by a control unit 11b of the server 1, and in that a team table 120, team reception count counters 121-1 to 121-3, and a team-by-team count table 123 about transmitting second item are stored in the memory unit 12 of the server 1. Overall, the communication system according to Embodiment 2 differs by tallying the second item transmission count for each group (team) formed by a plurality of users and ranking the teams. The following describes the present embodiment for the case in which there are three teams. The team names are respectively team A, team B, and team C.

Upon receiving an item acquisition request, the control unit 11b tallies the team reception count of item acquisition requests based on the team to which the user belongs. When determining that the team reception count is a multiple of the predetermined value, the control unit 11b transmits the second item data in addition to the first item data to the communication terminal 2 via the communication unit 10. The predetermined value is, for example 48, in which case the control unit 11b provides the second item to the communication terminal 2 when the reception count is 48 times, 96 times, 144 times, etc. Below, the case of the predetermined value being 48 is described. Note that the control for transmission of the winning image data and the non-winning image data is the same as in Embodiment 1.

The control unit 11b also determines whether the predetermined time period has elapsed, and when determining that the predetermined time period has elapsed, transmits information including the second item transmission count to the communication terminal 2 via the communication unit 10. The information includes information pertaining to a ranking of the second item transmission count for the team to which the user of the communication terminal 2 belongs. The information preferably includes the team name for each team having at least a predetermined ranking.

The memory unit 12 according to Embodiment 2 stores the team table 120, the team reception count counters 121-1 to 121-3, the second item transmission count table 122, and the team-by-team count table 123 about transmitting second item.

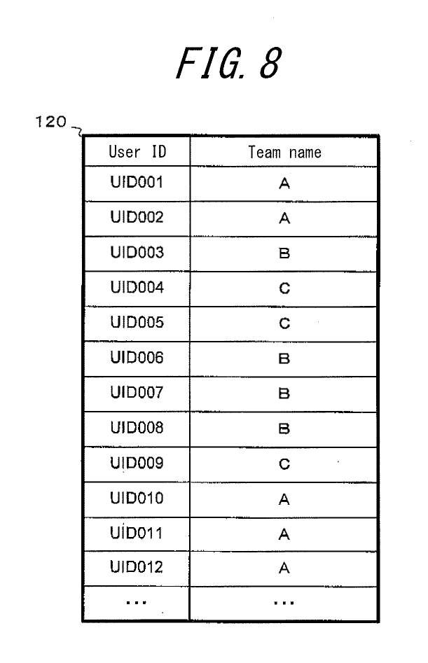

The team table 120 stores information pertaining to the teams to which the users belong. FIG. 8 is an example of the team table 120. As illustrated in FIG. 8, user IDs and team names are stored in the team table 120. For example, user ID “UID001” and team name “A” are stored in the team table 120. By referring to the team table 120, the control unit 11b can determine the team to which each user belongs.

The reception count counters 121-1 to 121-3 are respective tallies of the reception counts for team A, team B, and team C. Upon receiving an item acquisition request, the control unit 11b increments one of the reception count counters 121-1 to 121-3 in the memory unit 12 by one based on the team to which the user of the communication terminal 2 belongs. When a value of one of the reception count counters 121-1 to 121-3 reaches the predetermined value, i.e. 48, the control unit 11b resets that reception count counter to zero. The control unit 11b determines whether the reception count is a multiple of the predetermined value based on whether the value of the corresponding one of the reception count counters 121-1 to 121-3 is 48.

The memory unit 12 also stores a team-by-team count table 123 about transmitting second item. The team-by-team count table 123 stores the second item transmission count for each team. When determining that the reception count for the item acquisition request from the communication terminal 2 is a multiple of the predetermined value, the control unit 11b increments the second item transmission count for the team to which the user of the communication terminal 2 belongs by one. The control unit 11b refers to the team-by-team count table 122 about transmitting second item and transmits result information including the second item transmission count for each team to the communication terminal 2 via the communication unit 10.

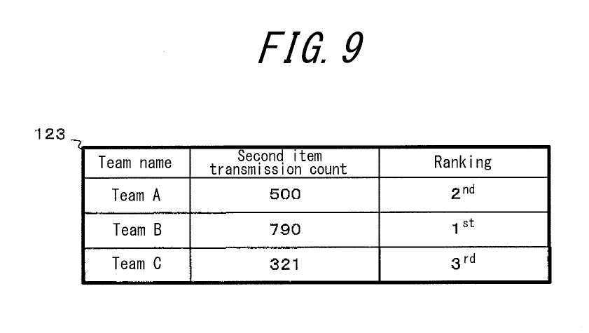

FIG. 9 illustrates an example of the team-by-team count table 123. As illustrated in FIG. 9, the team-by-team count table 123 includes team names and second item transmission counts. As also illustrated in FIG. 9, the team-by-team count table 123 also preferably includes a ranking of teams by the second item transmission count. For example, the team-by-team count table 123 includes team name “A”, second item transmission count “500”, and ranking “2^{nd}”. The control unit 11b refers to the team-by-team count table 123 and transmits result information including the second item transmission count to the communication terminal 2.

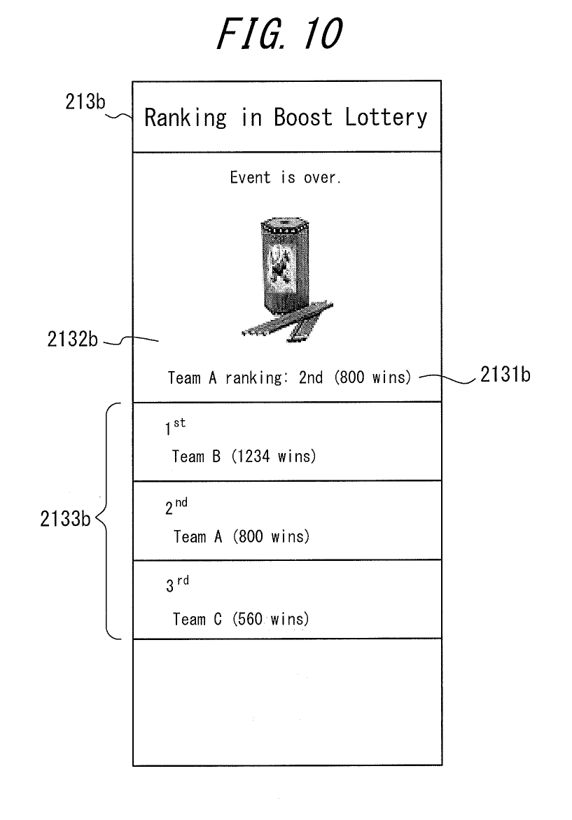

FIG. 10 illustrates an example of a result information screen 213b displayed on the display unit 21 of the communication terminal 2 when the communication terminal 2 receives the result information from the server 1. The result information screen 213b includes count information 2131b about transmitting second item pertaining to the team to which the user of the communication terminal 2 belongs. As illustrated in FIG. 10, ranking information 2132b for the team is also included. Count information 2133b about transmitting second item with the team name for each team having at least a predetermined ranking, along with the second item transmission count for the team, is also included.

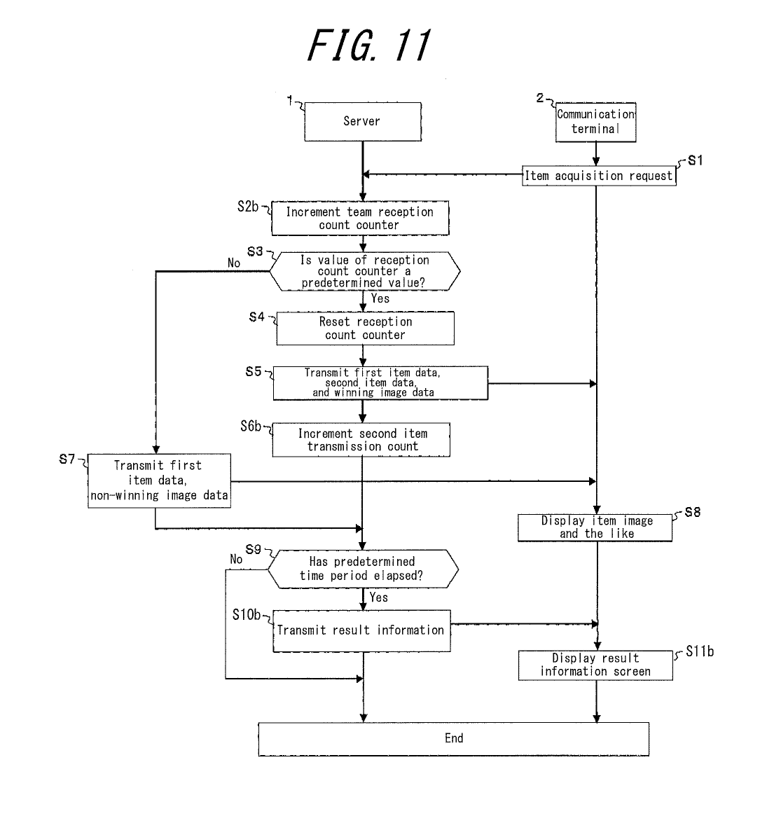

Next, operations of the communication system according to Embodiment 2 are described with reference to the flowchart in FIG. 11. The same reference signs are provided for the same operations as in Embodiment 1, and a description thereof is omitted.

After step S1, the control unit 11b of the server 1 tallies the team reception count of item acquisition requests based on the team to which the user belongs (step S2b). Specifically, upon receiving an item acquisition request, the control unit 11b determines the user's team based on the team table 120 in the memory unit 12 and increments the reception count counter (one of the reception count counters 121-1 to 121-3) for the team to which the user belongs by one.

After step S5, the control unit 11b of the server 1 increments the second item transmission count for the team to which the user of the communication terminal 2 belongs in the team-by-team count table 123 about transmitting second item by one (step S6b). Operations for step S3 through step S5 and step S7 through step S9 are the same, except that one of the reception count counters 121-1 to 121-3 is used instead of the reception count counter 121.

After step S9, when determining that the predetermined time period has elapsed, the control unit 11b transmits result information including the second item transmission count and the team ranking to the communication terminal 2 via the communication unit 10 (step S10b). The display unit 21 of the communication terminal 2 then displays the result information screen 213b based on the result information (step S11b).

According to the communication system of Embodiment 2, the control unit 11b of the server 1 controls the reception count and the second item transmission count for each team, thus making it possible to encourage competition between teams and enhance user interest in the game.

Note that the control unit 11b of the server 1 may provide a predetermined item to the communication terminal 2 of the user at each rank in accordance with the ranking pertaining to the second item transmission count.

The reception count counters 121-1 to 121-3 stored in the memory unit 12 have been described as being reset to zero upon reaching the predetermined value, yet the reception count counters 121-1 to 121-3 need not be reset to zero. As an alternative configuration, the control unit 11b may determine whether the reception count is a multiple of the predetermined value based on whether the remainder when dividing the value of the reception count counters 121-1 to 121-3 by the predetermined value is zero. In this case, the control unit 11b transmits the remainder to the communication terminal 2, and the communication terminal 2 displays the counter value 212 in the non-winning image data based on the remainder.

### Embodiment 3

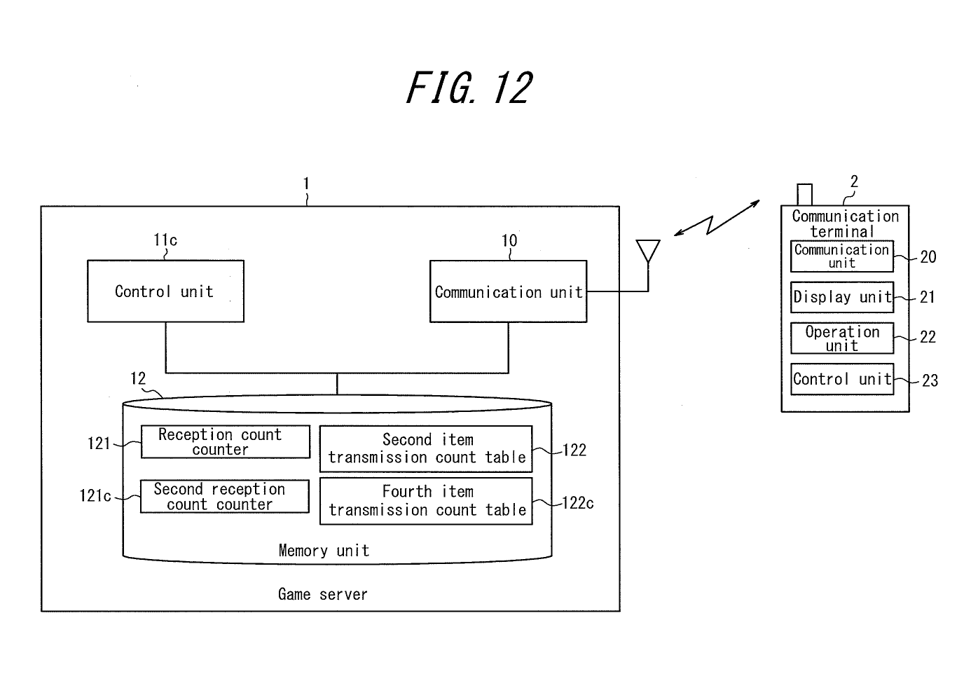

The following describes Embodiment 3 of the present invention. FIG. 12 is a block diagram of a communication system according to Embodiment 3 of the present invention. The same reference signs are provided for the same components as in Embodiment 1, and a description thereof is omitted. The communication system according to Embodiment 3 differs from Embodiment 1 with regard to control by a control unit 11c in the server 1, and in that a second reception count counter 121c and a fourth item transmission count table 122c are stored in the memory unit 12. Overall, the communication system according to Embodiment 3 differs by receiving a second item acquisition request from the communication terminal 2, and in accordance with the number of times the second item acquisition request has been received (reception count), further provides an additional item to the communication terminal 2. When the communication terminal 2 makes an item acquisition request for the first time and the item acquisition request is a win, the second item acquisition request refers to how an item acquisition request can be made additionally for a second time.

The control unit 11c of the server 1 provides an input interface for the second item acquisition request in the winning image data and transmits the winning image data to the communication terminal 2 via the communication unit 10.

Upon receiving the second item acquisition request, the control unit 11c provides a predetermined item (referred to below as a “third item”) to the communication terminal 2. Specifically, the control unit 11c transmits item data pertaining to the third item (referred to below as “third item data”) to the communication terminal 2 via the communication unit 10. The control unit 11c receives the second item acquisition request from the communication terminal 2 and tallies a reception count of the second item acquisition request. When determining that the reception count is a multiple of a predetermined value, the control unit 11c transmits item data pertaining to a fourth item (referred to below as “fourth item data”) to the communication terminal 2 in addition to the third item. Below, the case of the predetermined value being 48 is described.

The control unit 11c also determines whether a predetermined time period has elapsed, and when the predetermined time period has elapsed, transmits result information to the communication terminal 2 via the communication unit 10 after the predetermined time period has elapsed. The result information includes the number of times the fourth item data has been transmitted (referred to below as a “fourth item transmission count”). The predetermined time period is, for example, 30 days. Preferably, the result information includes information pertaining to a ranking, among all users of the system, of the fourth item transmission count for the user of the communication terminal 2. Furthermore, the result information preferably includes a user name for each user having at least a predetermined ranking.

The memory unit 12 stores a second reception count counter 121c for tallying the reception count of the second item acquisition request. Upon receiving a second item acquisition request, the control unit 11c increments the second reception count counter 121c in the memory unit 12 by one. When the value of the second reception count counter 121c reaches the predetermined value, i.e. 48, the control unit 11c resets the second reception count counter 121c to zero. The control unit 11c determines whether the reception count is a multiple of the predetermined value based on whether the value of the second reception count counter 121c is 48.

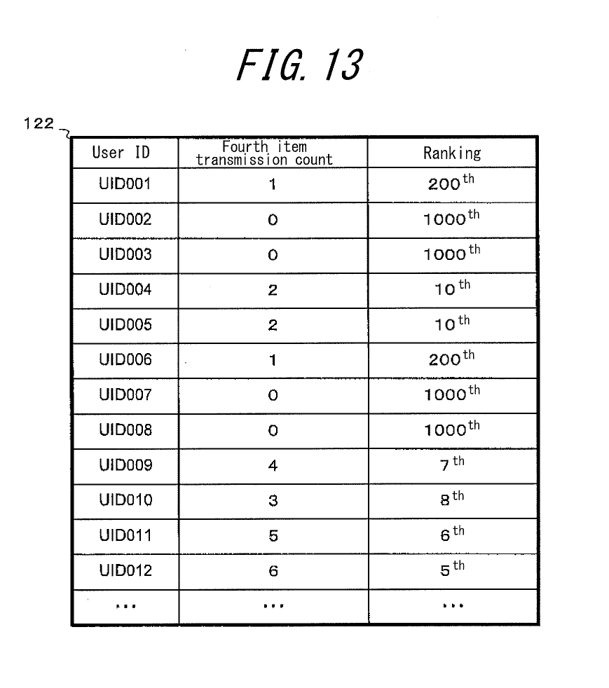

The memory unit 12 also stores a fourth item transmission count table 122c. The fourth item transmission count table 122c stores the fourth item transmission count for each user (FIG. 13). When determining that the reception count for the second item acquisition request from the communication terminal 2 is a multiple of the predetermined value, the control unit 11c increments the fourth item transmission count for the user of the communication terminal 2 by one. The control unit 11c refers to the fourth item transmission count table 122c and transmits result information to the communication terminal 2 via the communication unit 10.

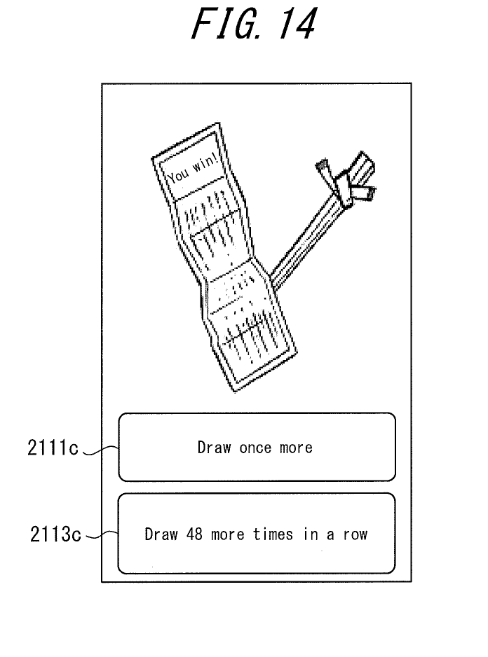

FIG. 14 illustrates an example of winning image data displayed on the display unit 21 of the communication terminal 2. The winning image data includes a second item acquisition request button 2111c for transmitting a second item acquisition request. As illustrated in FIG. 14, a request button 2113c for acquiring items continuously is also preferably included. The request button 2113c is an input interface for transmitting an item acquisition request continuously 48 times, which equals the predetermined value. When the communication terminal 2 transmits an item acquisition request to the server 1 with the request button 2113c, the fourth item will always be obtained. When the control unit 11c of the server 1 receives an item acquisition request from the communication terminal 2 via the request button 2113c, the control unit 11c increments the fourth item transmission count for the user of the communication terminal 2 in the memory unit 12 by one without incrementing the second reception count counter 121c in the memory unit 12.

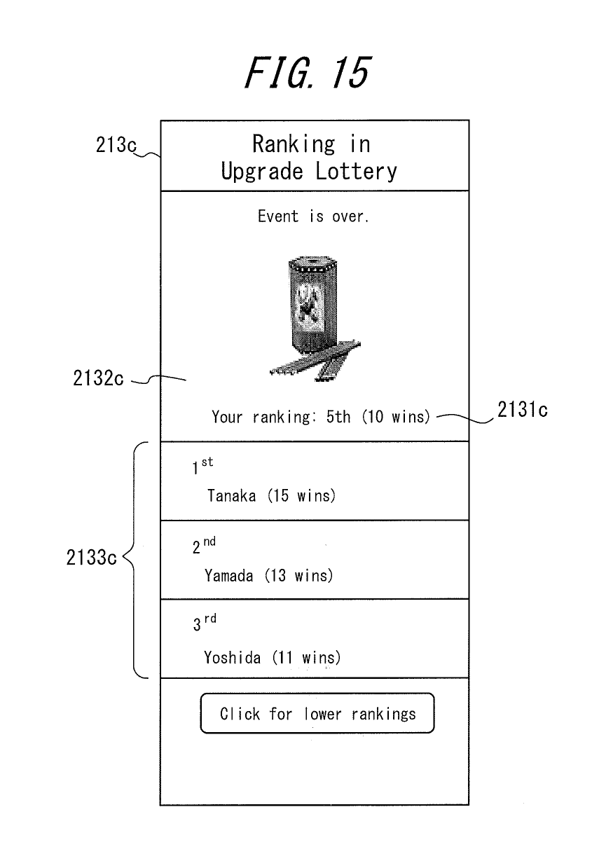

FIG. 15 illustrates an example of a result information screen 213c displayed on the display unit 21 of the communication terminal 2 when the communication terminal 2 receives, from the server 1, result information including the fourth item transmission count. The result information screen 213c includes count information about transmitting fourth item 2131c pertaining to the user of the communication terminal 2. As illustrated in FIG. 15, ranking information 2132c for the user is preferably included. As also illustrated in FIG. 15, count information 2133c about transmitting fourth item with a user name for each user having at least a predetermined ranking, along with the fourth item transmission count for the user, is more preferably included. FIG. 15 shows an example in which the user name and the fourth item transmission count are included for the top three users.

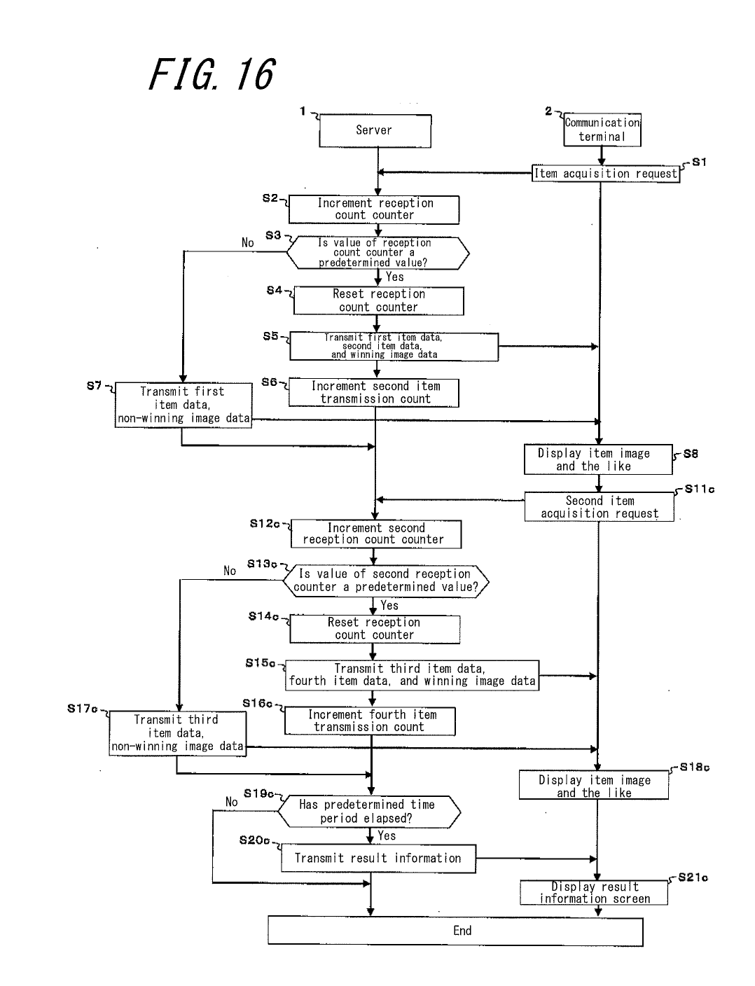

Next, operations of the communication system according to Embodiment 3 are described with reference to the flowchart in FIG. 16. The same reference signs are provided for the same operations as in Embodiment 1, and a description thereof is omitted.

In the communication system according to Embodiment 3, after step S8, based on user operation of the operation unit 22, the control unit 23 of the communication terminal 2 transmits a second item acquisition request to the server 1 via the communication unit 20 (step S11c). Note that the second item acquisition request is made with the second item acquisition request button 2111c in the winning image data displayed in step S8.

Next, upon receiving the second item acquisition request, the control unit 11c of the server 1 tallies the reception count (step S12c). Specifically, upon receiving the second item acquisition request, the control unit 11c increments the second reception count counter 121c in the memory unit 12 by one.

The control unit 11c then determines whether the value of the second reception count counter 121c is the predetermined value, i.e. 48 (step S13c). When the control unit 11c determines that the value of the second reception count counter 121c is the predetermined value, processing proceeds to step S14c. On the other hand, when the control unit 11c determines that the value of the second reception count counter 121c is not the predetermined value, processing proceeds to step S17c.

In step S13c, when determining that the value of the second reception count counter 121c is the predetermined value, the control unit 11c resets the second reception count counter 121c to zero (step S14c). The control unit 11c then transmits the third item data, the fourth item data, and the winning image data to the communication terminal 2 (step S15c). Next, the control unit 11c increments the fourth item transmission count for the user of the communication terminal 2 in the fourth item transmission count table 122c by one (step S16c). Processing then proceeds to step S18c. On the other hand, when determining that the value of the second reception count counter 121c is not the predetermined value, the control unit 11c transmits the third item data and the non-winning image data to the communication terminal 2 via the communication unit 10 (step S17c).

The display unit 21 of the communication terminal 2 then displays an item image pertaining to the received item data and displays either the winning image data or the non-winning image data (step S18c).

Next, the control unit 11c of the server 1 determines whether a predetermined time period has elapsed (step S19c). When determining that the predetermined time period has elapsed, the control unit 11c transmits result information including information on the second item transmission count and the fourth item transmission count to the communication terminal 2 via the communication unit 10 (step S20c). The display unit 21 of the communication terminal 2 then displays the result information screen 213c based on the result information (step S21c). Processing then terminates.

According to the communication system of Embodiment 3, after providing a second item, the control unit 11c of the server 1 thus provides a third item as well as an additional item (fourth item) in accordance with the reception count of the second item acquisition request, thereby further increasing the variations on methods for acquiring an item.

A computer is preferably used to function as the communication terminal 2. A program containing the processing for achieving the functions of the communication terminal 2 is stored in the memory unit of the computer, and the functions are achieved by the central processing unit (CPU) of the computer reading and executing the program.

Although the present invention has been described based on the drawings and embodiments, it should be noted that various changes and modifications will be apparent to those skilled in the art based on the present disclosure. Therefore, such changes and modifications are to be understood as included within the scope of the present invention. For example, the functions and the like included in the various units, steps, and the like may be reordered in any logically consistent way. Furthermore, units, steps, and the like may be combined into one or divided.

### REFERENCE SIGNS LIST

1: Server

2: Communication terminal

10: Communication unit

11, 11b, 11c: Control unit

12: Memory unit

20: Communication unit

21: Display unit

22: Operation unit

23: Control unit

120: Team table

121, 121-1 to 121-3: Reception count counter

121c: Second reception count counter

122: Second item transmission count table

122c: Fourth item transmission count table

123: Team-by-team count table

211: Item acquisition request screen

212: Count value

213, 213b, 213c: Result information screen

2111, 2111c: Item acquisition request button

2112: Box image

2113, 2113c: Request button

2114: Time period information

2131, 2131b: Count information

2131c: Count information

2132, 2132b, 2132c: Ranking information

2133, 2133b: Count information

2133c: Count information

1. A communication system comprising a plurality of communication terminals and a server, wherein
the communication terminals transmit an item acquisition request to the server, and
upon receiving the item acquisition request, the server transmits first item data pertaining to a first item to the communication terminals, and when a reception count of a number of times the item acquisition request is received from the communication terminals reaches a predetermined value, transmits second item data pertaining to a second item to a communication terminal, among the communication terminals, that transmitted the item acquisition request for which the reception count reached the predetermined value,
wherein
the server tallies a second item transmission count for each user of the communication terminals within a predetermined time period and transmits result information including the second item transmission count to the communication terminals, and
the communication terminals display the second item transmission count based on the result information.

2. The communication system according to claim 1, wherein
the server transmits count information pertaining to the reception count to the communication terminals, and
the communication terminals display the reception count based on the count information.

3. The communication system according to claim 1, wherein
the result information includes ranking information pertaining to a ranking of the second item transmission count, and
the communication terminals display the ranking of the user of the communication terminal based on the result information.

4. The communication system according to claim 3, wherein
the result information includes a user name of each user for which the second item transmission count is at least a predetermined ranking, and
the communication terminals display the user name of each user for which the second item transmission count is at least the predetermined ranking.

5. The communication system according to claim 1, wherein
the server allocates a user of each communication terminal to a team among a plurality of teams,
the reception count is the number of times the item acquisition request is received for each of the teams,
within a predetermined time period, the server tallies a total second item transmission count team by team for every user belonging to each team and transmits result information including ranking information pertaining to a ranking of the total second item transmission count to the communication terminals, and
each communication terminal displays the ranking of the team to which the user of the communication terminal belongs based on the result information.

6. The communication system according to claim 1, wherein
the communication terminals transmit a second item acquisition request to the server when the reception count is the predetermined value, and
the server tallies a second reception count of a number of times the second item acquisition request is received, and when the second reception count reaches a predetermined value, transmits fourth item data pertaining to a fourth item to a communication terminal, among the communication terminals, that transmitted the second item acquisition request for which the second reception count reached the predetermined value.

7. The communication system according to claim 1, wherein
the server stores related user information pertaining to a related user of a user of each communication terminal, and
upon the server transmitting the second item data to the communication terminal, the server notifies the related user that the user has acquired the second item, based on the related user information.

8. A communication system comprising a plurality of communication terminals and a server, wherein
the communication terminals transmit an item acquisition request to the server, and
upon receiving the item acquisition request, the server transmits first item data pertaining to a first item to the communication terminals, and when a reception count of a number of times the item acquisition request is received from the communication terminals reaches a predetermined value, transmits second item data pertaining to a second item to a communication terminal, among the communication terminals, that transmitted the item acquisition request for which the reception count reached the predetermined value, wherein
the server allocates a user of each communication terminal to a team among a plurality of teams,
the reception count is the number of times the item acquisition request is received for each of the teams,
within a predetermined time period, the server tallies a total second item transmission count team by team for every user belonging to each team and transmits result information including ranking information pertaining to a ranking of the total second item transmission count to the communication terminals, and
each communication terminal displays the ranking of the team to which the user of the communication terminal belongs based on the result information.

9. A communication system comprising a plurality of communication terminals and a server, wherein
the communication terminals transmit an item acquisition request to the server, and
upon receiving the item acquisition request, the server transmits first item data pertaining to a first item to the communication terminals, and when a reception count of a number of times the item acquisition request is received from the communication terminals reaches a predetermined value, transmits second item data pertaining to a second item to a communication terminal, among the communication terminals, that transmitted the item acquisition request for which the reception count reached the predetermined value, wherein
the communication terminals transmit a second item acquisition request to the server when the reception count is the predetermined value, and
the server tallies a second reception count of a number of times the second item acquisition request is received, and when the second reception count reaches a predetermined value, transmits fourth item data pertaining to a fourth item to a communication terminal, among the communication terminals, that transmitted the second item acquisition request for which the second reception count reached the predetermined value.

10. A communication system comprising a plurality of communication terminals and a server, wherein
the communication terminals transmit an item acquisition request to the server, and
upon receiving the item acquisition request, the server transmits first item data pertaining to a first item to the communication terminals, and when a reception count of a number of times the item acquisition request is received from the communication terminals reaches a predetermined value, transmits second item data pertaining to a second item to a communication terminal, among the communication terminals, that transmitted the item acquisition request for which the reception count reached the predetermined value, wherein
the server stores related user information pertaining to a related user of a user of each communication terminal, and
upon the server transmitting the second item data to the communication terminal, the server notifies the related user that the user has acquired the second item, based on the related user information.

11. A method for controlling a communication system comprising a plurality of communication terminals and a server, the server transmitting first item data pertaining to a first item to the communication terminals in response to an item acquisition request from the communication terminals, the method comprising:
transmitting, by the communication terminals, the item acquisition request to the server;
tallying, by the server, a reception count of a number of times the item acquisition request is received from the communication terminals;
determining, by the server, whether the reception count reaches a predetermined value; and
transmitting, by the server when the reception count is determined to reach the predetermined value, second item data pertaining to a second item to a communication terminal, among the communication terminals, that transmitted the item acquisition request for which the reception count reached the predetermined value, further comprising:
tallying, by the server, a second item transmission count for each user of the communication terminals within a predetermined time period and transmitting result information including the second item transmission count to the communication terminals; and
displaying, by the communication terminals, the second item transmission count based on the result information.

12. The method according to claim 11, further comprising:
transmitting, by the server, count information pertaining to the reception count to the communication terminals; and
displaying, by the communication terminals, the reception count based on the count information.

13. The method according to claim 11, wherein
the result information includes ranking information pertaining to a ranking of the second item transmission count, and
the communication terminals display the ranking of the user of each communication terminal based on the result information.

14. The method according to claim 13, wherein
the result information includes a user name of each user for which the second item transmission count is at least a predetermined ranking, and
the communication terminals display the user name of each user for which the second item transmission count is at least the predetermined ranking.

15. The method according to claim 11, wherein
the server allocates a user of each communication terminal to a team among a plurality of teams, and
the reception count is the number of times the item acquisition request is received for each of the teams,
the method further comprising:
tallying, by the server, within a predetermined time period, a total second item transmission count team by team for every user belonging to each team and transmitting result information including ranking information pertaining to a ranking of the second item transmission count to the communication terminals; and
displaying, by each communication terminal, the ranking of the team to which the user of the communication terminal belongs based on the result information.

16. The method according to claim 11, further comprising:
transmitting, by the communication terminals, a second item acquisition request to the server when the reception count is the predetermined value, and
tallying, by the server, a second reception count of a number of times the second item acquisition request is received, and when the second reception count reaches a predetermined value, transmitting fourth item data pertaining to a fourth item to a communication terminal, among the communication terminals, that transmitted the second item acquisition request for which the second reception count reached the predetermined value.

17. The method according to claim 11, wherein
the server stores related user information pertaining to a related user of a user of each communication terminal,
the method further comprising:
upon the server transmitting the second item data to the communication terminal, notifying, by the server, the related user that the user has acquired the second item, based on the related user information.

18. A method for controlling a communication system comprising a plurality of communication terminals and a server, the server transmitting first item data pertaining to a first item to the communication terminals in response to an item acquisition request from the communication terminals, the method comprising:
transmitting, by the communication terminals, the item acquisition request to the server;
tallying, by the server, a reception count of a number of times the item acquisition request is received from the communication terminals;
determining, by the server, whether the reception count reaches a predetermined value; and
transmitting, by the server when the reception count is determined to reach the predetermined value, second item data pertaining to a second item to a communication terminal, among the communication terminals, that transmitted the item acquisition request for which the reception count reached the predetermined value, wherein
the server allocates a user of each communication terminal to a team among a plurality of teams, and
the reception count is the number of times the item acquisition request is received for each of the teams,
the method further comprising:
tallying, by the server, within a predetermined time period, a total second item transmission count team by team for every user belonging to each team and transmitting result information including ranking information pertaining to a ranking of the second item transmission count to the communication terminals; and
displaying, by each communication terminal, the ranking of the team to which the user of the communication terminal belongs based on the result information.

19. A method for controlling a communication system comprising a plurality of communication terminals and a server, the server transmitting first item data pertaining to a first item to the communication terminals in response to an item acquisition request from the communication terminals, the method comprising:
transmitting, by the communication terminals, the item acquisition request to the server;
tallying, by the server, a reception count of a number of times the item acquisition request is received from the communication terminals;
determining, by the server, whether the reception count reaches a predetermined value; and
transmitting, by the server when the reception count is determined to reach the predetermined value, second item data pertaining to a second item to a communication terminal, among the communication terminals, that transmitted the item acquisition request for which the reception count reached the predetermined value, further comprising:
transmitting, by the communication terminals, a second item acquisition request to the server when the reception count is the predetermined value, and
tallying, by the server, a second reception count of a number of times the second item acquisition request is received, and when the second reception count reaches a predetermined value, transmitting fourth item data pertaining to a fourth item to a communication terminal, among the communication terminals, that transmitted the second item acquisition request for which the second reception count reached the predetermined value.

20. A method for controlling a communication system comprising a plurality of communication terminals and a server, the server transmitting first item data pertaining to a first item to the communication terminals in response to an item acquisition request from the communication terminals, the method comprising:
transmitting, by the communication terminals, the item acquisition request to the server;
tallying, by the server, a reception count of a number of times the item acquisition request is received from the communication terminals;
determining, by the server, whether the reception count reaches a predetermined value; and
transmitting, by the server when the reception count is determined to reach the predetermined value, second item data pertaining to a second item to a communication terminal, among the communication terminals, that transmitted the item acquisition request for which the reception count reached the predetermined value, wherein
the server stores related user information pertaining to a related user of a user of each communication terminal,
the method further comprising:
upon the server transmitting the second item data to the communication terminal, notifying, by the server, the related user that the user has acquired the second item, based on the related user information.
